(19) United States
(12) Patent Application Publication
(10) Pub. No.: US 2011/0032636 A1
(43) Pub. Date: Feb. 10, 2011

(54) ENHANCED HEAD SKEW OPTIMIZATION FOR HIGH SPEED DISK ACCESS

(75) Inventor: ByeungJun Lee, Saratoga, CA (US)

Correspondence Address: IRELL & MANELLA LLP, 1800 AVENUE OF THE STARS, SUITE 900, LOS ANGELES, CA, 90067, US

(73) Assignee: Samsung Electronics Co., Ltd., Suwon City (KR)

(21) Appl. No.: 12/536,396

(22) Filed: Aug. 5, 2009

(51) Int. Cl. G11B 21/02; G11B 20/20

(52) U.S. Cl. 360/76; G9B/21.003; G9B/5.201

(57) ABSTRACT

A hard disk drive with multiple heads coupled to multiple disks. The disk drive switches between heads when writing or reading data to access different disk surfaces. As described above, there is a head skew time associated with switching heads. The disk drive includes a circuit that switches heads in accordance with a sequence that is a function of a head skew value. For example, the sequence may include switching from a first head to a third head and from a third head to a second head.

### BACKGROUND OF THE INVENTION

1. Field of the Invention

The present invention relates to switching heads during a write or read routine of a hard disk drive.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGAs are suspended from an actuator arm. The actuator arm has a voice coil motor that can move the heads across the surfaces of the disks.

Information is stored in radial tracks that extend across the surfaces of each disk. Each track is typically divided into a number of segments or sectors. The voice coil motor and actuator arm can move the heads to different tracks of the disks.

Each disk is coupled to a pair of heads located adjacent to the disk surfaces. When data is written the drive can switch heads so that some of the data is written on one disk surface and other data is written on a different disk surface. There is a time delay between the writing of one head and the writing of a different head. This time delay is commonly referred to as head skew. Head skew can include a head switching time, a head setting time and a controller ready time. When the heads are switched on the same track such skew is typically referred to as track skew. If the heads are switched to write or read on different tracks the skew is referred to as cylinder skew.

The skew time can be set by the manufacturer and stored in the drive. The skew time is used to delay writing or reading when the heads are switched to new track or disk surface in a sequential data access. U.S. Pat. No. 5,835,299 discloses a scheme where the head skew is measured for each individual disk drive. It is desirable to further optimize disk drives to minimize the effects of head skew.

### BRIEF SUMMARY OF THE INVENTION

A hard disk drive that includes a plurality of heads coupled to a plurality of disks. The disk drive changes head to access sequential data in some locations. This invention includes the way to find the optimal head change sequence for optimal data access time instead of using fixed head change sequence.

### BRIEF DESCRIPTION OF THE DRAWINGS

FIG. 1 is a top view of an embodiment of a hard disk drive;

FIG. 2 is a schematic of an electrical circuit for the hard disk drive;

FIG. 3 is a flowchart showing a routine to determine an optimal skew value and head switching sequence.

### DETAILED DESCRIPTION

Described is a hard disk drive with multiple heads coupled to multiple disks. The disk drive switches between heads when writing or reading data to access different disk surfaces. As described above, there is a head skew time associated with switching heads. The disk drive includes a circuit that switches heads in accordance with a sequence that is a function of a head skew value. For example, the sequence may include switching from a first head to a third head and from a third head to a second head. This is to be distinguished from prior art techniques where the sequence was fixed to switch from head 0, to head 1, then to head 2 and then head 3 with a fixed head skew time. Optimal head switching sequences and head skew values can be selected to minimize the total skew time. This approach can reduce the time to access sequential data in different track and improve the sequential performance.

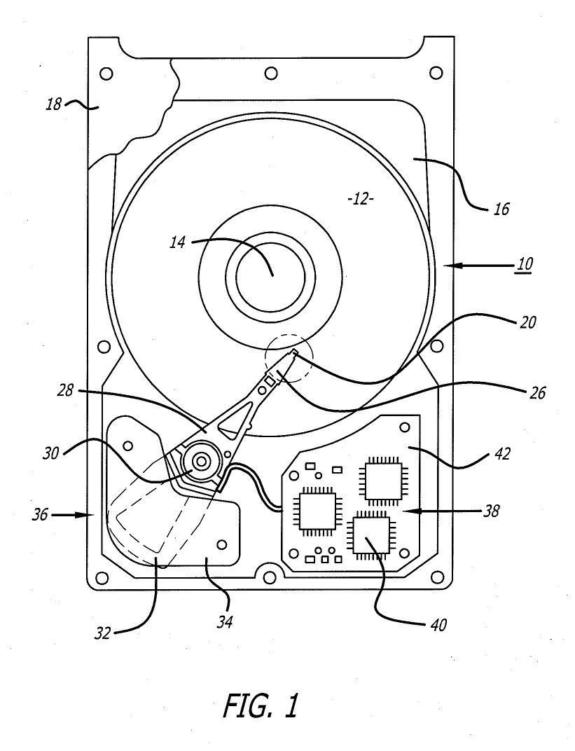

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements. The write element magnetizes the disk 12 to write data. The read element senses the magnetic fields of the disks 12 to read data. By way of example, the read element may be constructed from a magneto-resistive material that has a resistance which varies linearly with changes in magnetic flux.

Each head 20 may be gimbal mounted to a suspension arm 26 as part of a head gimbal assembly (HGA). The suspension arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes one or more integrated circuits 40 coupled to a printed circuit board 42. The printed circuit board 40 is coupled to the voice coil 32, heads 20 and spindle motor 14 by wires (not shown).

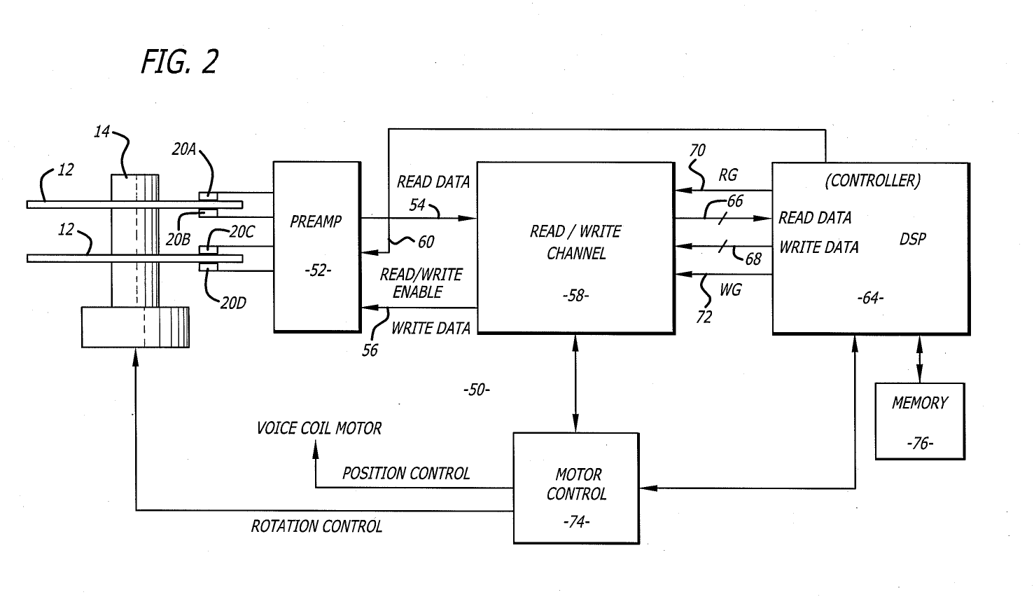

FIG. 2 shows an electrical circuit 50 for reading and writing data onto the disks 12. The circuit 50 may include a pre-amplifier circuit 52 that is coupled to a first head 20A, a second head 20B, a third head 20C and a fourth head 20D. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write date 72 is enabled when writing data to the disks 12. The controller 64 may be a digital signal processor that operates in accordance with a software routine, including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”) that contains instructions that are read by the controller 64.

When performing a write or read routine the controller 64 may switch between the first 20A, second 20B, third 20C and fourth 20D heads. The switching can be performed in accordance with a skew time. The sequence of switching is a function of skew values. For example, the skew values may be minimized by switching from the first head to the third head, from the third head to the second head and from the second head to the fourth head.

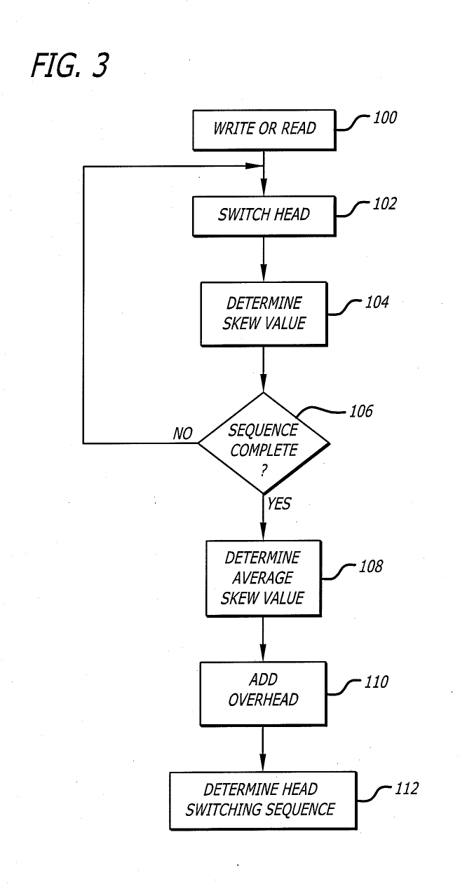

FIG. 3 shows a method for determining an average skew value and an optimal head switching sequence. This can be performed by a routine of the controller of the drive. Thus each drive may determine a skew value and head switching sequence that is unique to the drive. In step 100 a head performs a write or read routine. In steps 102 and 104 the controller switches to a new head and a skew time is determined, respectively. In decision block 106, it is determined whether the skew time for the last head switching sequence has been determined. If not, the routine returns to step 102 and the process is repeated. The skew times for a plurality of different head sequences are determined. This may include skew times for every possible head change sequences.

If the determination in decision block 106 is yes, then in block 108 an average head skew value and a standard deviation is determine from all the skew values determined in block 104. Some amount of overhead may be added to the average skew value in block 110. The head switching sequence is determined in block 112. For example, it may be determined that skew time is minimized if the heads switch from the first head to the third head, instead of switching to the second head as is done in the prior art.

The optimal skew value and head switching sequences are stored in non-volatile memory or on the disk. When performing a write or read routine the controller can utilize the skew values and head switching sequences.

There are many locations in a drive where head switch is necessary for sequential data access. Optimal head switch sequence can be decided for all the necessary positions.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a plurality of disks;
a plurality of heads coupled to said disks;
an actuator arm coupled to said heads;
a voice coil motor coupled to said actuator arm; and,
a circuit that switches between said heads in accordance with a sequence that is a function of a head skew time.

2. The hard disk drive of claim 1, wherein said head skew time is an average of a plurality of head skew times determined by switching between said heads.

3. The hard disk drive of claim 1, wherein said sequence includes switching from one head to another head.

4. The hard disk drive of claim 1, wherein said circuit includes a controller.

5. A hard disk drive, comprising:
a plurality of disks;
a plurality of heads coupled to said disks;
an actuator arm coupled to said all the heads;
a voice coil motor coupled to said actuator arm; and,
circuit means for switching between said heads in accordance with a sequence that is a function of a head skew time.

6. The hard disk drive of claim 5, wherein said head skew time is an average of a plurality of head skew times determined by switching between said heads.

7. The hard disk drive of claim 5, wherein said sequence includes switching from said one head to another head.

8. A method for switching between heads of a hard disk drive, comprising:
performing a write routine with a head;
switching to a different head in accordance with a switching sequence that is a function of a head skew time; and,
performing a write routine with the different head.

9. The method of claim 8, further comprising performing read routines with the head and the different head.

10. The method of claim 8, wherein the head skew time is determined by an average of a plurality of head skew times determined by switching between a plurality of heads.

11. A method to determine an optimal head switch sequence, comprising;
providing a plurality of heads coupled to a plurality of disks;
determining a plurality of skew values for a plurality of head switching sequences; and,
determining at least one optimal head switching sequence.
